(19) United States
(12) Patent Application Publication
(10) Pub. No.: US 2017/0367479 A1
(43) Pub. Date: Dec. 28, 2017

(54) BOTTLE RACK

(71) Applicant: Chih-Chien HSIEH, Taichung City (TW)

(72) Inventor: Chih-Chien HSIEH, Taichung City (TW)

(21) Appl. No.: 15/190,465

(22) Filed: Jun. 23, 2016

(51) Int. Cl. A47B 73/00; A47B 96/06; F16B 1/00

(52) U.S. Cl. CPC A47B 73/00; F16B 1/00; A47B 96/068; A47B 2230/0022; F16B 2001/0035

(57) ABSTRACT

A bottle bracket includes a main frame divided into an assembling portion and a supporting portion, wherein at least one slot is defined in the assembling portion. At least one bracket is selectively positioned on the assembling portion. The at least one bracket includes a mounting portion abutting against the assembling portion and having at least one bore defined therein. A first holder extends from a top edge of the mounting portion and at least one through hole is defined in the first holder for allowing a bottle extending through the first holder, wherein the bottle stands on the supporting portion after extending through the at least one opening. At least one fastener sequentially extends through the at least one slot and the at least one through hole and for selectively positioning the at least one bracket due to a clamping effect thereof.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates to a bottle rack, and more particularly to a bottle rack that is adjusted relative to a height of the bottle(s) thereon.

### 2. Description of Related Art Including Information Disclosed Under 37 CFR 1.97 And 37 CFR 1.98

In our daily lives, especially in the kitchen, many bottles are used for containing seasoning or sauces. These bottles may be dumped due to an improper touch during cooking processes when the bottles do not be arranged in order such that the cooking environment is polluted and need to be cleaned. Another place we may use various bottles for containing solutions, such as spray cleaning solution, is the garage.

Whatever the kitchen or the garage, the bottles have a common feature that is a round cross-section. In other words, the bottles may roll everywhere. At best, the bottle(s) cannot be easily found; at worst, the operator may fall when stepping the turned bottle. In view of this, an elongated bottle rack is marketed. The conventional bottle rack has a groove for partially receiving the bottles. However, the depth of the groove in the conventional bottle rack is fixable. As a result, the bottle cannot be easily found when the bottle is short and the bottle may lose balance when the bottle is tall.

The present invention has arisen to mitigate and/or obviate the disadvantages of the conventional

### BRIEF SUMMARY OF THE INVENTION

The main objective of the present invention is to provide an improved bottle rack that is adjusted relative to a height of the bottle(s) thereon.

To achieve the objective, the bottle rack in accordance with the present invention comprises a main frame divided into an assembling portion and a supporting portion, wherein at least one slot is longitudinally defined in the assembling portion and the supporting portion is adapted to support bottle(s). At least one bracket is selectively fixed on the main frame and includes a mounting portion selectively slidably mounted onto the assembling portion. At least one bore is defined in the mounting portion and communicating with the at least one slot. A holder extends from an upper edge of the mounting portion and has a first through hole defined therein, wherein the bottle(s) stands on the supporting portion after extending through the first through hole. At least one fastener is screwed onto the bracket for selectively positioning the bracket on the main frame. The at least one fastener includes a bolt and a nut, wherein the bolt includes a head and a threaded stub extending from the head. The head selectively securely abuts a back of the assembling portion and the nut is screwed onto the threaded stub after the threaded stub sequentially extending through the at least one slot and the at least one bore, wherein the mounting portion of the at least one bracket is securely clamped between the nut and the head such that the at least one bracket is fastened on the assembling portion of the main frame.

Further benefits and advantages of the present invention will become apparent after a careful reading of the detailed description with appropriate reference to the accompanying drawings.

### BRIEF DESCRIPTION OF THE SEVERAL VIEWS OF THE DRAWINGS

FIG. 1 is an exploded perspective view of a first preferred embodiment of a bottle rack in accordance with the present invention.

FIG. 1A is a perspective view of a first preferred embodiment of the bottle rack in accordance with the present invention.

FIG. 2 is a perspective view of a second preferred embodiment of the bottle rack in accordance with the present invention.

FIG. 3 is an exploded perspective view of a second preferred embodiment of the bottle rack in accordance with the present invention.

FIG. 4 is an operational view of the second preferred embodiment of the bottle rack in accordance with the present invention when adjusting the height of the bracket.

FIG. 5 is a perspective view of a third preferred embodiment of the bottle rack in accordance with the present invention.

FIG. 6 is a partially exploded perspective view of a third preferred embodiment of the bottle rack in accordance with the present invention.

FIG. 7 is a front plan view of the third preferred embodiment of the bottle rack in accordance with the present invention.

FIG. 8 is top plan view in cross-section of the bottle rack in accordance with the present invention.

FIG. 9 is an operational view of the third preferred embodiment of the bottle rack in accordance with the present invention when adjusting the brackets relative to the heights of the bottles.

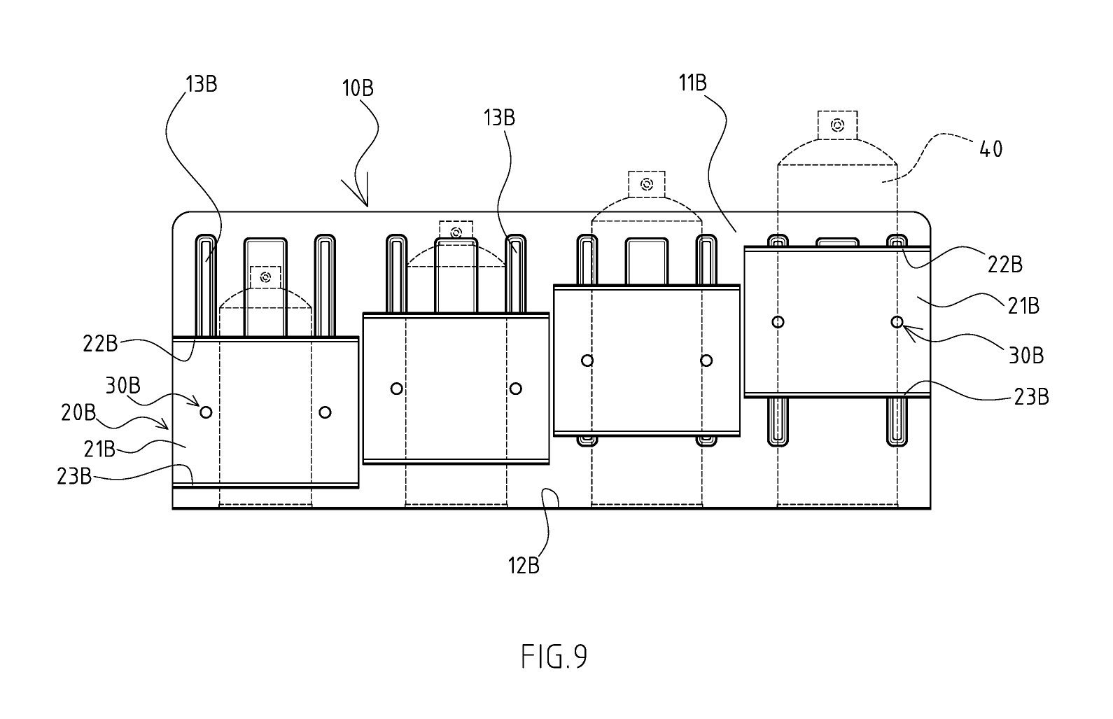

### DETAILED DESCRIPTION OF THE INVENTION

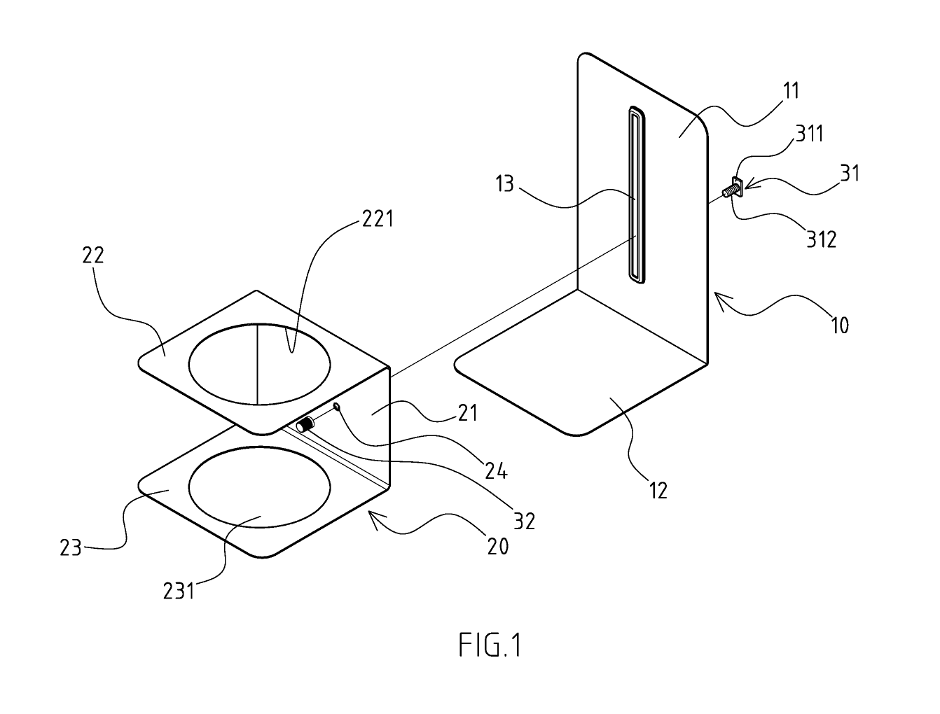

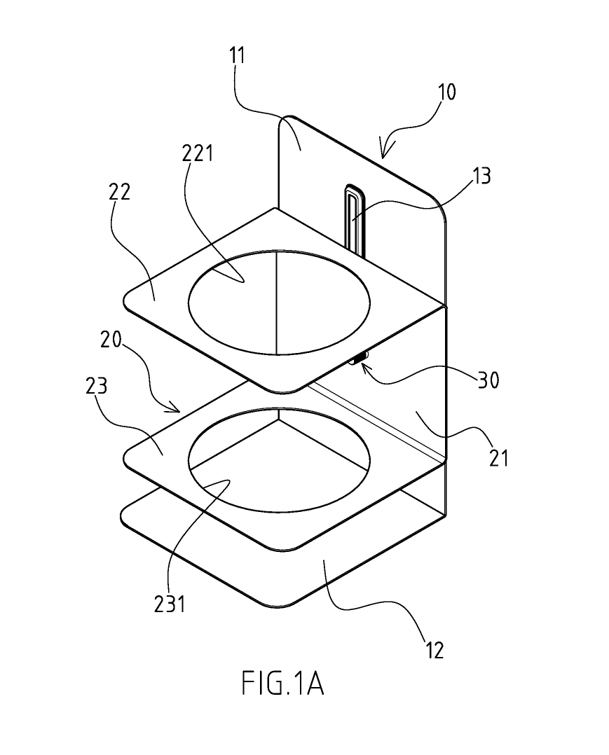

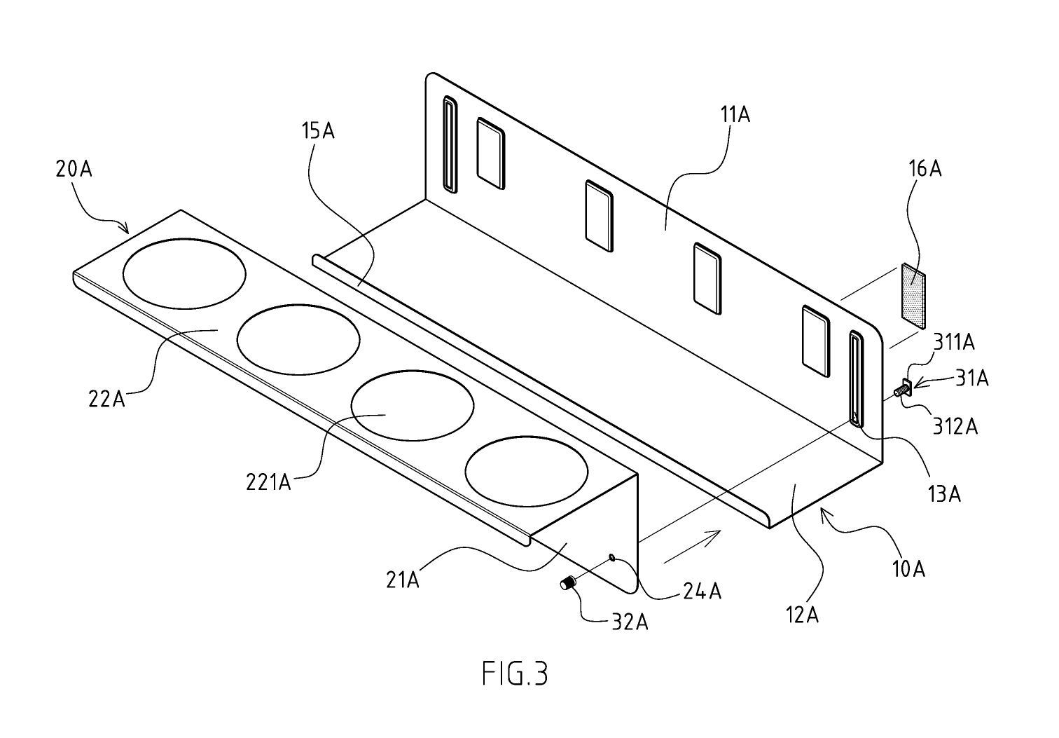

Referring to the drawings and initially to FIGS. 1-3, a bottle rack in accordance with the present invention comprises a main frame 10 and a bracket 20 selectively fixed on the main frame 10. The main frame 10 has an L-shaped cross-section divided into an assembling portion 11 and a supporting portion 12, wherein the assembling portion 11 has a slot 13 longitudinally defined therein. A recess 14 is defined in a back of the assembling portion 11 and the slot 13 is defined along a midline of the recess 14. The recess 14 has a width greater than that of the slot 13. The bracket 20 includes a mounting portion 21 selectively slidably mounted onto the assembling portion 11. The mounting portion 21 includes a first holder 22 and a second holder 23 respectively extending from an upper edge and a lower edge of the mounting portion 21. The first holder 22 has a first through hole 221 defined therein and the second holder 23 has a second through hole 231 defined therein, wherein the first through hole 221 and the second through hole 231 co-axially correspond to each other. A bore 24 is defined in the mounting portion 21 and communicates with the slot 13. A fastener 30 is screwed onto the bracket 20 for selectively positioning the bracket 20 on the main frame 10. The fastener 30 includes a bolt 31 and a nut 32. The bolt 31 includes a head 311 and a threaded stub 312 extending from the head 311, wherein the head 311 is received in the recess 14 and selectively securely abutting a bottom of the recess 14. The recess 14 has a depth greater than a thickness of the head 311. The nut 32 is screwed onto the threaded stub 312 after the threaded stub 312 sequentially extending through the slot 13 and the bore 24 for fastening the bracket 20. The mounting portion 21 of the bracket 20 is securely clamped between the nut 32 and the head 311 such that the bracket 20 is fastened on the assembling portion 11 of the main frame 10. In the preferred embodiment of the present invention, the extending length of the threaded stub 312 is smaller than a minimized distance between the periphery of the first through hole 221 and the mounting portion 21.

When arranging the bottle (not showing), the bottle stands on the supporting portion 12 of the main frame 10 after sequentially extending through first through hole 221 and the second through hole 231. When adjusting the position of the bracket 20 relative to the assembling portion 11 of the main frame 10 due to the height of the bottle, the bracket 20 is freely moved on the assembling portion 11 when the nut 32 is released and the bracket 20 is fastened against after adjusting the height of the bracket 20 relative to the height of the bottle.

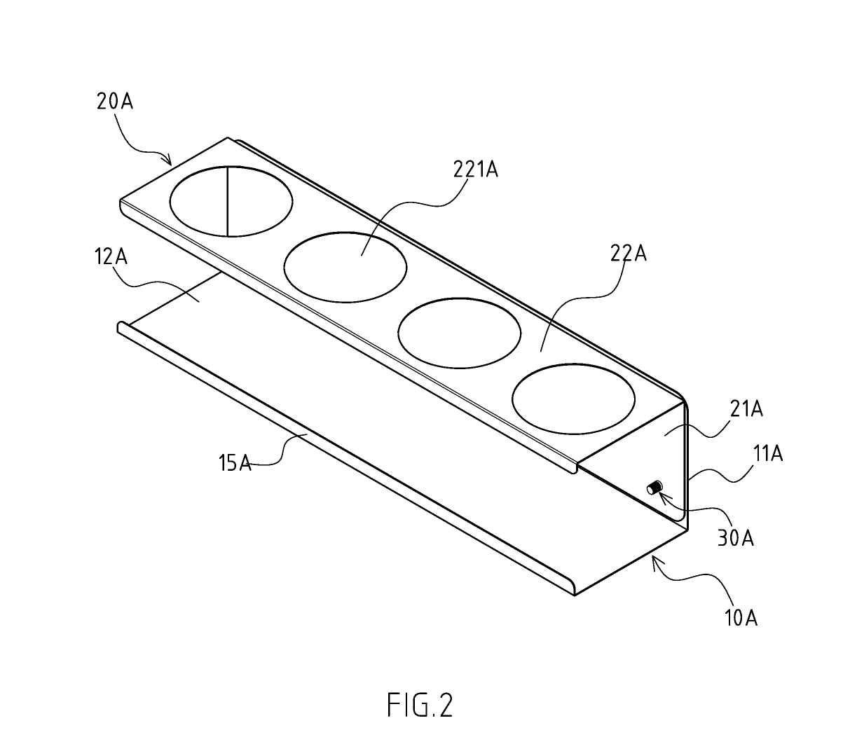

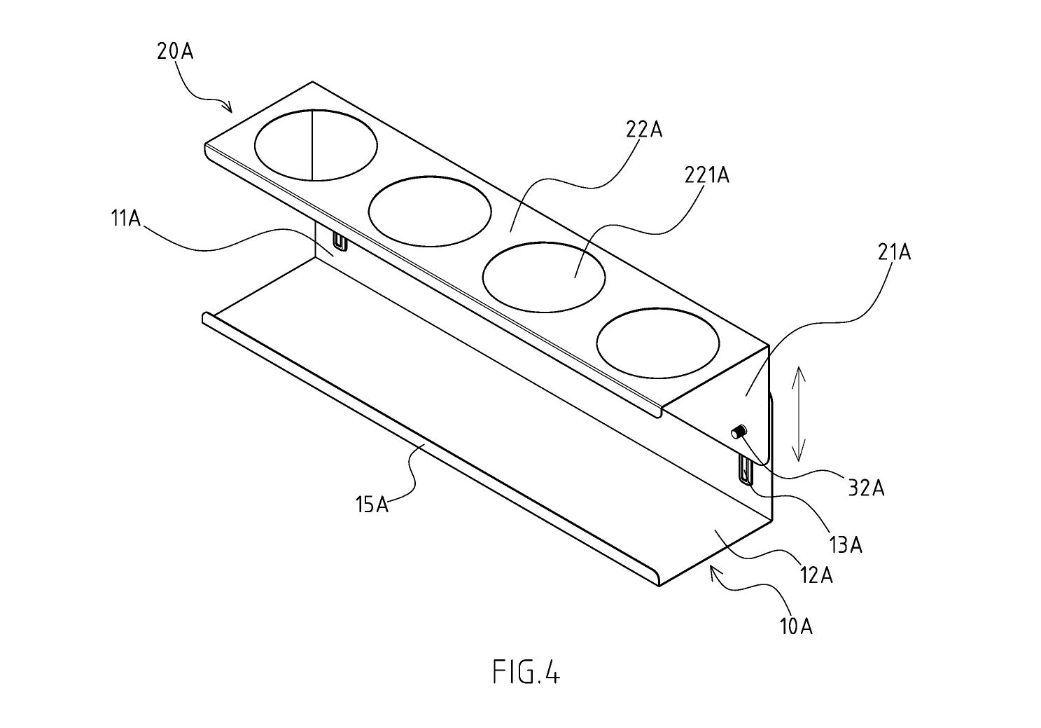

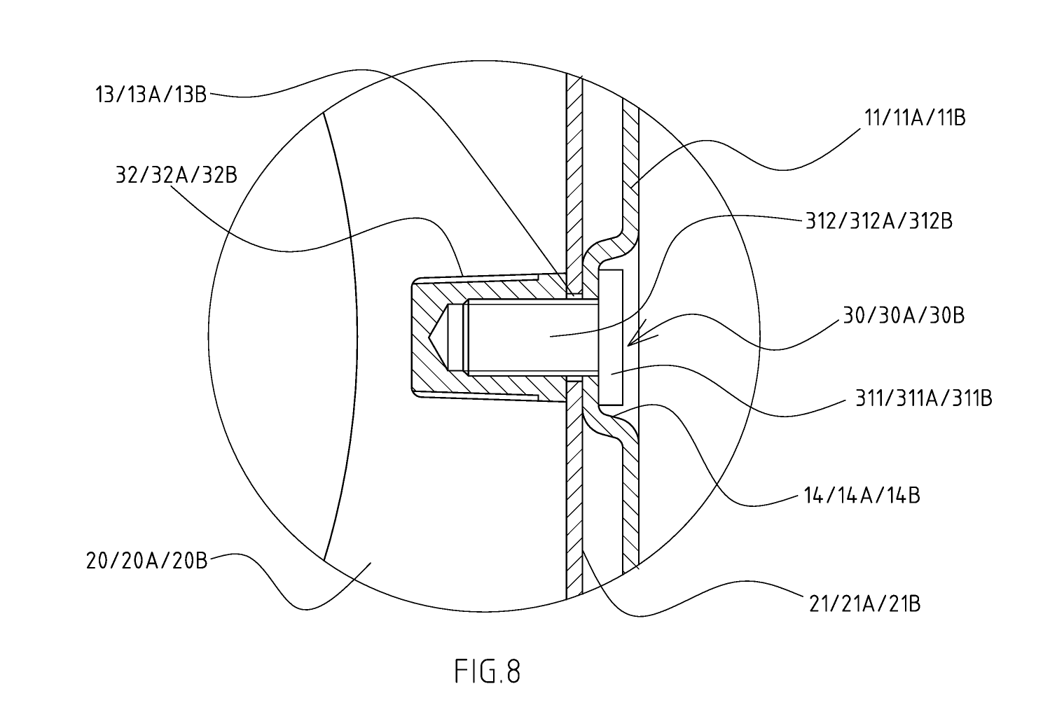

With reference to FIGS. 2 to 4 and 8 that show a second embodiment of the bottle rack in accordance with the present invention, in this embodiment, the bottle rack in accordance with the present invention comprises a main frame 10A and a bracket 20A selectively fixed on the main frame 10A. The main frame 10A has an L-shaped cross-section divided into an assembling portion 11A and a supporting portion 12A, wherein the assembling portion 11A has two parallel slots 13A longitudinally defined therein. Two recesses 14A are defined in a back of the assembling portion 11A and each slot 13 is defined along a midline of a corresponding one of the two recesses 14A. The recess 14A has a width greater than that of the slot 13A. The main frame 10A includes a protrusion 15A upwardly extending from a front edge of the supporting portion 12A. The bracket 20A includes a mounting portion 21A selectively slidably mounted onto the assembling portion 11A. The mounting portion 21A includes a holder 22A extending from an upper edge thereof. The holder 22A has multiple through holes 221A defined therein. Two bores 24A are respectively defined in the mounting portion 21A and each communicates with a corresponding one of the two slots 13A. Two fasteners 30A are respectively screwed onto the bracket 20A for selectively positioning the bracket 20A on the main frame 10A. Each fastener 30A includes a bolt 31A and a nut 32A. The bolt 31A includes a head 311A and a threaded stub 312A extending from the head 311A, wherein the head 311A is received in a corresponding one the two recesses 14A and selectively securely abutting a bottom of the corresponding recess 14A. The nut 32A is screwed onto the threaded stub 312A after the threaded stub 312A sequentially extending through the corresponding slot 13A and the corresponding bore 24A for fastening the bracket 20A. The main frame 10A includes multiple magnets 16A disposed on a back of the assembling portion 11A of the main frame 10A such that the bottle rack in accordance with the present invention is capable of temporarily securing on an iron cabinet. In addition, the bottle rack in accordance with the present invention also can be mounted onto a wall or directly put on a tabletop.

The mounting portion 21A of the bracket 20A is securely clamped between the two nuts 32A and the heads 311A of the two bolts 31A such that the bracket 20A is fastened on the assembling portion 11A of the main frame 10A. When arranging the bottle(s) (not shown), the bottle(s) stands on the supporting portion 12A of the main frame 10A after extending through the through hole 221A. The protrusion 15A is provided for preventing the arranged bottle(s) form overly inclined relative to the supporting portion 12A and detaching from the bracket 20A. When adjusting the position of the bracket 20A relative to the assembling portion 11A of the main frame 10A due to the height of the bottle, the bracket 20A is freely moved on the assembling portion 11A when the nut 32A is released and the bracket 20A is fastened against after adjusting the height of the bracket 20A relative to the height of the bottle. The second preferred embodiment of the bottle rack in accordance with the present invention is capable of arranging multiple bottles that are consistent with one another.

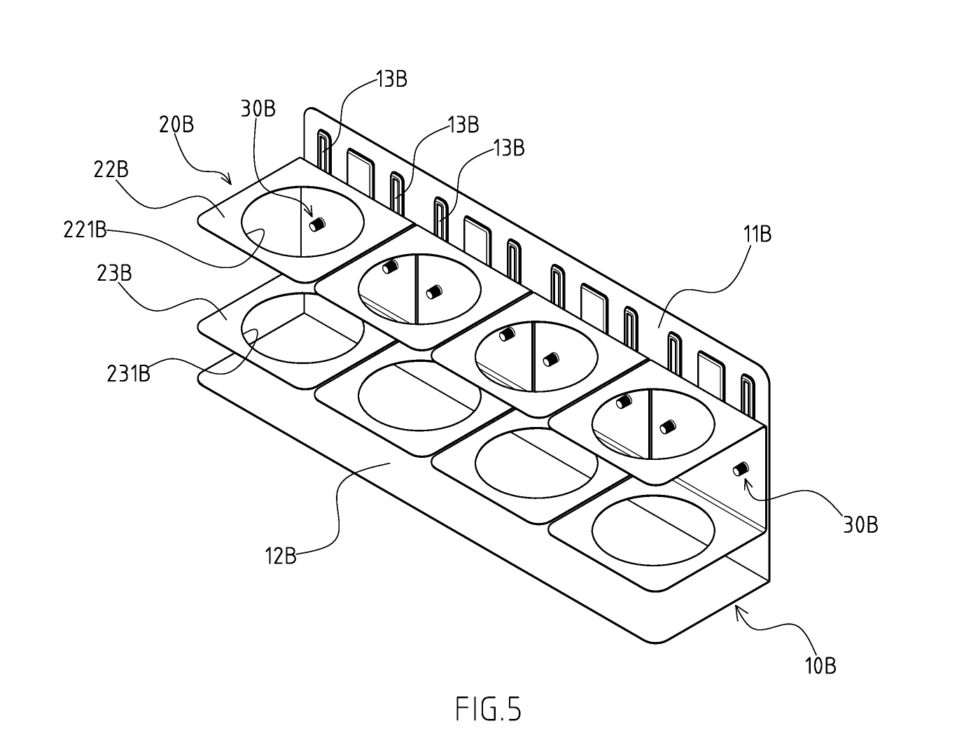

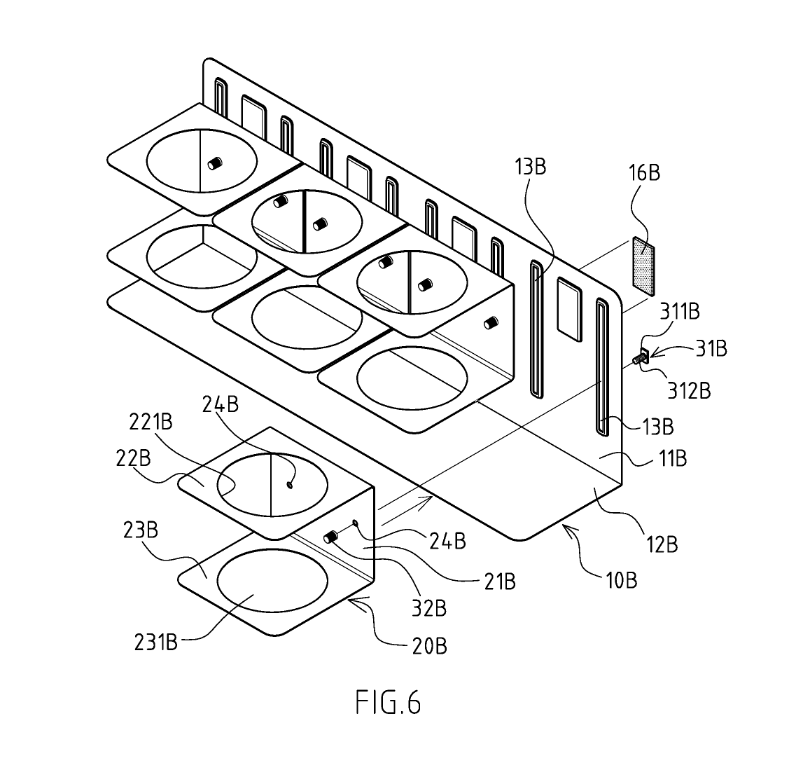

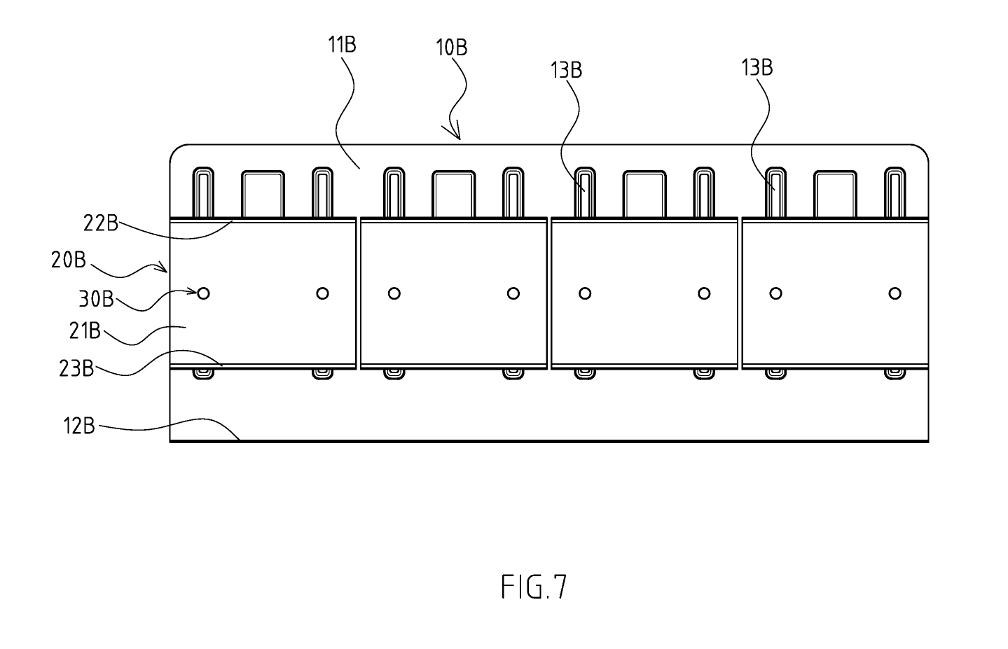

With reference to FIGS. 5 to 8 that show a third embodiment of the bottle rack in accordance with the present invention, in this embodiment, the bottle rack in accordance with the present invention comprises a main frame 10B and multiple brackets 20B selectively fixed on the main frame 10B. The main frame 10B has an L-shaped cross-section divided into an assembling portion 11B and a supporting portion 12B, wherein the assembling portion 11A has multiple parallel slots 13B longitudinally defined therein. Multiple recesses 14B are defined in a back of the assembling portion 11B and each slot 13 is defined along a midline of a corresponding one of the multiple recesses 14B. The recess 14B has a width greater than that of the slot 13B. Each bracket 20B includes a mounting portion 21B selectively slidably mounted onto the assembling portion 11B. Each mounting portion 21B includes a first holder 22B and a second holder 23B respectively extending from an upper edge and a lower edge thereof. Each first holder 22A has a first through hole 221B defined therein and each second holder 23B has a second through hole 231B defined therein, wherein the first through hole 221B and the second through hole 231B co-axially correspond to each other. Each mounting portion 21B has two bores 24B defined therein and each bore 24B communicates with a corresponding one of the multiple slots 13B. Multiple fasteners 30B are respectively screwed onto the bracket 20B for selectively positioning the bracket 20B on the main frame 10B. Each fastener 30B includes a bolt 31B and a nut 32B. The bolt 31B includes a head 311B and a threaded stub 312B extending from the head 311B, wherein each head 311B is received in a corresponding one the multiple recesses 14B and selectively securely abutting a bottom of the corresponding recess 14B. The nut 32B is screwed onto the threaded stub 312B after the threaded stub 312B sequentially extending through the corresponding slot 13B and the corresponding bore 24B for fastening the bracket 20B. The main frame 10B includes multiple magnets 16B disposed on a back of the assembling portion 11B of the main frame 10B such that the bottle rack in accordance with the present invention is capable of temporarily securing on an iron cabinet. In addition, the bottle rack in accordance with the present invention also can be mounted onto a wall or directly put on a tabletop. With reference to FIGS. 1, 3 and 6, the nut 32/32A/32B of the preferred embodiments of the present invention has a cylinder structure such that the operator can easily and directly rotate the nut 32/32A/32B with his/her fingers.

The mounting portion 21B of each of the brackets 20B is securely clamped between the two nuts 32B and the heads 311B of the two bolts 31B such that the bracket 20B is fastened on the assembling portion 11B of the main frame 10B. When arranging the bottles, the bottles stand on the supporting portion 12B of the main frame 10B after sequentially extending through the first through hole 221B and the second through hole 231B in the bracket 20B. When adjusting the position of the brackets 20B relative to the assembling portion 11B of the main frame 10B due to the heights of the bottles, each bracket 20B is freely moved on the assembling portion 11B when the nuts 32B are released and the brackets 20B are fastened against after adjusting the height of each of the bracket 20B relative to the height of each of the bottles.

Although the invention has been explained in relation to its preferred embodiment, it is to be understood that many other possible modifications and variations can be made without departing from the spirit and scope of the invention as hereinafter claimed.

I claim:

1. A bottle rack comprising:
a main frame divided into an assembling portion and a supporting portion, wherein at least one slot is longitudinally defined in the assembling portion and the supporting portion is adapted to support bottle(s);
at least one bracket selectively fixed on the main frame, the at least one bracket including a mounting portion selectively slidably mounted onto the assembling portion, at least one bore defined in the mounting portion and communicating with the at least one slot; a first holder extending from an upper edge of the mounting portion and having a first through hole defined therein, wherein the bottle(s) stands on the supporting portion after extending through the first through hole; and
at least one fastener screwed onto the bracket for selectively positioning the bracket on the main frame, the at least one fastener includes a bolt and a nut, wherein the bolt includes a head and a threaded stub extending from the head, the head selectively securely abutting a back of the assembling portion and the nut screwed onto the threaded stub after the threaded stub sequentially extending through the at least one slot and the at least one bore, wherein the mounting portion of the at least one bracket is securely clamped between the nut and the head such that the at least one bracket is fastened on the assembling portion of the main frame.

2. The bottle rack as claimed in claim 1, wherein an extending length of the threaded stub is smaller than a minimized distance between the periphery of the first through hole and the mounting portion.

3. The bottle rack as claimed in claim 2, wherein the main frame includes a protrusion upwardly extending from a front edge of the supporting portion and the protrusion is provided for preventing the arranged bottle(s) form overly inclined relative to the supporting portion and detaching from the bracket.

4. The bottle rack as claimed in claim 2, wherein the main frame includes multiple slots defined in the assembling portion thereof and multiple brackets are respectively selectively fixed on the assembling portion of the main frame, the at least one bore in each mounting portion of each of the multiple brackets communicating with a corresponding one of the multiple slots, the first holder of each of the multiple brackets has a first through hole defined therein.

5. The bottle rack as claimed in claim 4, wherein a second holder extends from a lower edge of the mounting portion of each of the multiple brackets and a second through hole defined in the second holder of each of the multiple brackets, the first through hole and the second through hole of each of the multiple brackets co-axially corresponding to each other, and adapted for arranging a bottle.

6. The bottle rack as claimed in claim 1, wherein at least one recess is defined in a back of the assembling portion, the at least one recess having a depth greater than a thickness of the at least one head and the recess having a width greater than that of the slot such that the at least one slot is defined along a midline of the at least one recess, the at least one head received in the at least one recess when the at least one bracket is positioned by the at least one fastener.

7. The bottle rack as claimed in claim 2, wherein at least one recess is defined in a back of the assembling portion, the at least one recess having a depth greater than a thickness of the at least one head and the at least one recess having a width greater than that of the slot such that the at least one slot is defined along a midline of the at least one recess, the at least one head received in the at least one recess when the at least one bracket is positioned by the at least one fastener.

8. The bottle rack as claimed in claim 3, wherein at least one recess is defined in a back of the assembling portion, the at least one recess having a depth greater than a thickness of the at least one head and the at least one recess having a width greater than that of the slot such that the at least one slot is defined along a midline of the at least one recess, the at least one head received in the at least one recess when the at least one bracket is positioned by the at least one fastener.

9. The bottle rack as claimed in claim 5, wherein multiple recesses are respectively defined in a back of the assembling portion, each recess having a depth greater than a thickness of the head and each recess having a width greater than that of each slot such that each slot is defined along a midline of a corresponding one of the multiple recesses, each head received in a corresponding one of the multiple recesses when the brackets positioned by the fasteners.

10. The bottle rack as claimed in claim 1, wherein the at least one nut has a cylinder structure such that the operator can easily and directly rotate the nut with his/her fingers.

11. The bottle rack as claimed in claim 2, wherein the at least one nut has a cylinder structure such that the operator can easily and directly rotate the nut with his/her fingers.

12. The bottle rack as claimed in claim 3, wherein the at least one nut has a cylinder structure such that the operator can easily and directly rotate the nut with his/her fingers.

13. The bottle rack as claimed in claim 5, wherein the at least one nut has a cylinder structure such that the operator can easily and directly rotate the nut with his/her fingers.

14. The bottle rack as claimed in claim 6, wherein the at least one nut has a cylinder structure such that the operator can easily and directly rotate the nut with his/her fingers.

15. The bottle rack as claimed in claim 7, wherein the at least one nut has a cylinder structure such that the operator can easily and directly rotate the nut with his/her fingers.

16. The bottle rack as claimed in claim 8, wherein the at least one nut has a cylinder structure such that the operator can easily and directly rotate the nut with his/her fingers.

17. The bottle rack as claimed in claim 9, wherein the at least one nut has a cylinder structure such that the operator can easily and directly rotate the nut with his/her fingers.

18. The bottle rack as claimed in claim 6, wherein the main frame includes multiple magnets disposed on a back of the assembling portion.

19. The bottle rack as claimed in claim 7, wherein the main frame includes multiple magnets disposed on a back of the assembling portion.

20. The bottle rack as claimed in claim 8, wherein the main frame includes multiple magnets disposed on a back of the assembling portion.
